(19) United States
(12) Patent Application Publication
(10) Pub. No.: US 2026/0112157 A1
(43) Pub. Date: Apr. 23, 2026

(54) SYSTEMS AND METHODS OF CAMERA-BASED MACHINE VISION MODEL RESOURCE ALLOCATION

(71) Applicant: Rhombus Systems, Sacramento, CA (US)

(72) Inventor: Brandon Salzberg, Sacramento, CA (US)

(73) Assignee: Rhombus Systems, Sacramento, CA (US)

(21) Appl. No.: 18/923,330

(22) Filed: Oct. 22, 2024

(51) Int. Cl. G06V 10/94; G06V 10/70; G06V 10/764; G06V 10/77; G06V 10/82

(52) U.S. Cl. CPC G06V 10/94; G06V 10/764; G06V 10/7715; G06V 10/82; G06V 10/87

(57) ABSTRACT

A camera-based machine vision system includes an image capture device and one or more processors coupled with memory. The image capture device outputs one or more images. The one or more processors detect a feature represented in a first image of the one or more images; select, based on the feature, a machine vision model to process at least one of the first image or a second image of the one or more images; allocate, to the machine vision model, based on a characteristic of the machine vision model, a portion of the memory; and execute the machine vision model using the portion of the memory to process the at least one of the first image or the second image.

### BACKGROUND

The present disclosure relates generally to the field of computer vision systems, and more particularly to systems and methods of camera-based machine vision model resource allocation. Machine vision models can perform operations including object detection, tracking, classification, and/or perception. However, it is challenging to perform such operations under conditions of high performance criteria, such as to perform real-time or near real-time classification in resource-constrained environments.

### SUMMARY

At least one aspect relates to a camera. The camera can include an image capture device and one or more processors coupled with memory. The image capture device can output one or more images. The one or more processors can detect a feature represented in a first image of the one or more images; select, based on the feature, a machine vision model to process at least one of the first image or a second image of the one or more images; allocate, to the machine vision model, based on a characteristic of the machine vision model, a portion of the memory; and execute the machine vision model using the portion of the memory to process the at least one of the first image or the second image.

At least one aspect relates to a method. The method can include selecting, by processing circuitry of a camera, a machine vision model to process one or more images from an image capture device of the camera; allocating a portion of memory of the camera, by the processing circuitry, based on a characteristic of at least one of the one or more images or the machine vision model; and executing, by the processing circuitry, the machine vision model on the portion of the memory to process the one or more images.

At least one aspect relates to a system. The system can include one or more processors to detect an object in image data from an image capture device, the object having a class; select, based on the class, a machine vision model to process the image stream; determine a target memory usage for the machine vision model; and execute the machine vision model, on a portion of memory corresponding to the target memory usage, to generate an output regarding the object based on the image data.

### BRIEF DESCRIPTION OF THE DRAWINGS

FIG. 1 is a schematic diagram of an example of an environment in which a camera is provided, in accordance with some implementations.

FIG. 2 is a block diagram of an example of a machine vision architecture, in accordance with some implementations.

FIG. 3 is a block diagram of an example of a machine vision system suitable for allocating memory and processing units to execution machine vision models, in accordance with some implementations.

FIG. 4A is a schematic diagram of an example of a convolutional neural network, in accordance with some implementations.

FIG. 4B is a schematic diagram of an example of a kernel of a convolutional neural network applied to an image, in accordance with some implementations.

FIG. 5A is a schematic diagram of an example of memory or processing unit allocation, in accordance with some implementations.

FIG. 5B is a schematic diagram of an example of potential memory or processing unit allocations for various machine vision models, in accordance with some implementations.

FIG. 5C is a schematic diagram of an example of another memory or processing unit allocation with several machine vision models, in accordance with some implementations.

FIG. 6 is a schematic diagram of an example of user interface for configuring a machine vision system, in accordance with some implementations.

FIG. 7A is a flow diagram of an example of a method for allocating memory or processing units responsive to detection of a feature of an image, in accordance with some implementations.

FIG. 7B is a flow diagram of an example of a method for allocating memory or processing units based on a data structure corresponding to the machine vision model, in accordance with some implementations.

FIG. 8A is a flow diagram of an example of a method for generating an alert responsive to the expected memory or processing units exceeding a threshold with a user interface, in accordance with some implementations.

FIG. 8B is a flow diagram of an example of a method for determining the requirements of a remote processing system used to execute machine vision models, in accordance with some implementations.

### DETAILED DESCRIPTION

Before turning to the figures, which illustrate certain implementations in detail, it should be understood that the present disclosure is not limited to the details or methodology set forth in the description or illustrated in the figures. It should also be understood that the terminology used herein is for the purpose of description only and should not be regarded as limiting.

Sensors can be deployed in various environments to capture or detect information regarding the environment. For example, cameras can be deployed in various environments to capture images, including image frames and video or other sequences of videos, of areas in fields of view of the cameras. For example, cameras can be mounted to structures inside and/or outside of buildings. The cameras can be positioned to monitor areas or zones including, for example and without limitation, rooms, storage areas, entryways, doorways, halls, access control points (e.g., gates or turnstiles), or windows.

The cameras can include various forms of image processing capabilities and/or be capable of transmitting detected images or image data thereof to one or more remote devices or systems. For example, one or more processors of one or both of a camera or a remote device communicatively coupled with the camera can perform various computer vision or other image processing operations on the image data. Such operations can include, for example and without limitation, event detection, motion detection, object detection, object tracking, person detection, person sentiment or mood detection, edge detection, shape detection, data detection, or various combinations thereof. Various sensors can be used to detect sensor data including image data or non-image data, including but not limited to various image, audio, thermal, weight/mass, or other sensors may also be used to detect information regarding the environment and/or persons in the environment.

For example, the cameras can include hardware to execute one or more machine vision models and/or computer vision models, including but not limited to neural network-based machine learning models for any of various inference operations described above. It can be useful for the majority or all of the processing performed by such machine vision models to be performed using hardware of the cameras, rather than in substantial conjunction with remote computing systems such as servers provided in a same building as the cameras and/or in a remote or cloud-based environment. For example, various applications from access control to manufacturing process monitoring can require accurate and fast (e.g., real-time or near real-time) processing, such as processing on the order of milliseconds or tens of milliseconds. However, performing the machine vision processing using hardware remote from the camera can add enough latency that the total processing time exceeds the timing criteria for the processing. At the same time, size, weight, and/or power constraints for the cameras can make it challenging to operate machine vision models, including to operate multiple machine visions models in sequence, such as in multiple stages of inferencing or in which models may be dependent on one another.

Systems and methods in accordance with the present disclosure can allow for higher performance deployment of machine vision models on cameras and/or hardware resources of cameras. For example, the system can selectively allocate memory and/or processing units in response to specific trigger events and/or features detected from initial processing of camera data. The system can perform the allocation based at least on a characteristic of the machine vision model to operate, such as an expected computational demand of the machine vision model. The system can perform the allocation based at least on properties of the images captured by the camera, such as frame rate and/or resolution. The system can monitor utilization of memory by the machine vision model, and manage the allocation and/or trigger alerts according to the utilization. The system can perform the allocation responsive to detecting features of interest in the images, which can allow for limiting the deployment of high demand machine vision models to specific instances in which the machine vision models are useful, and can reduce the allocation and/or deallocate memory responsive to tasks assigned to the machine vision models being completed. The system can allow for modular development and deployment of machine vision models on cameras, including for multiple camera deployments.

### Machine Vision Environments

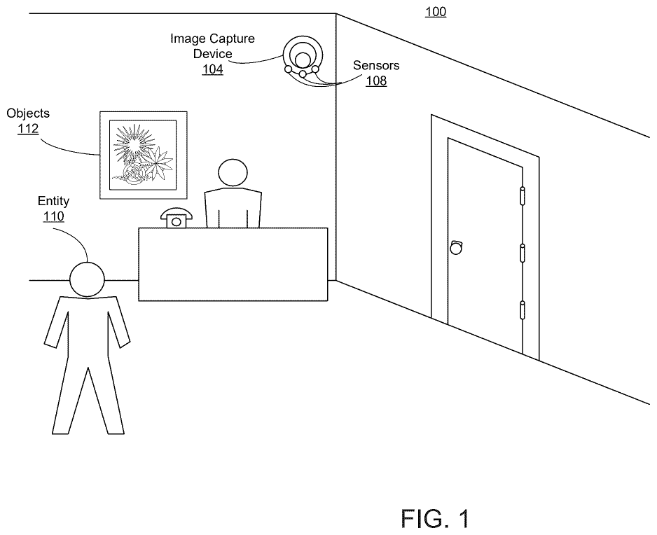

FIG. 1 depicts an example of an environment 100 in which an image capture device is provided. The environment 100 can be any setting, location, or place in which an image capture device is provided to capture images of the environment 100. For example, the environment 100 can include or be an office space, a room of a building, a hallway, manufacturing facility, storage space, medical facility, or an outdoors area such as a pavilion or walkway, or any combination thereof. The environment 100 can include objects 112 within it such as furniture, walls, windows, fixtures, or other such static or moving objects 112; as described further herein, images captured by the image capture device 104 may include image data indicative of the objects 112 or features thereof, such as edges, segments, shapes, colors, or other optical or visual features, characteristics, or parameters.

The environment 100 can include an entity 110. The entity 110 can be or include one or more people, animals, groups of persons, or other such persons or animals. The entity 110 can include a body and behaviors. The body can include arms, legs, a face, head, eyes, fingers, hands, feet, legs, among other body parts. The behavior can include motions associated with the body (e.g., gait, facial movements, gesticulations) as well as sounds or speech patterns. While FIG. 1 depicts a person as an example of the entity 110; in various implementations, the entity 110 can correspond to any of various objects and/or subjects regarding which to perform machine vision operations, such as medical or manufacturing parts or objects, robotic devices, or movable assets, for example and without limitation.

The environment 100 can include an image capture device 104 coupled with sensors 108. In brief overview of the system, the sensors 108 can detect a parameter indicative of the entity 110 and can perform various operations according to the parameter detected by the sensors 108. These operations can include processing of sensor data and/or camera data using one or more machine vision models.

The image capture device 104 can be a visible light camera (e.g., color or black and white or grayscale), infrared camera, ultraviolet camera, or combinations thereof. The image capture device 104 can be a video camera. The image capture device 104 can include one or more lenses, of which a zoom function can be controlled. The image capture device 104 can include a lens to receive light corresponding to a field of view of the image capture device 104 and to provide the light to an image sensor of the sensors 108 that generates one or more images based on the received light. The image sensor 108 can provide image data including the one or more images (or video, or an image stream) to any processors and/or communications circuitry of the image capture device 104. The image sensor 108 can include sensor circuitry, including but not limited to charge-coupled device (CCD) or complementary metal-oxide-semiconductor (CMOS) circuitry, which can detect the light received via the lens and generate images based on the received light.

The image capture device 104 can receive light from the environment 100 and generate images and/or image data based on the received light. The image capture device 104 can have respective fields of view. The field of view can correspond to a region of the environment 100 from which a lens or sensor (e.g., the sensors 108) receives light to generate images. The image capture device 104 can capture still images or videographic information of any sort and may capture image or videographic information with the application of a variety of filters (such as, for example, filters that enable to ability to capture images or video at night). In some implementations, the image capture device 104 can be an infrared camera, a visible light camera, or any combination thereof. The image capture device 104 can output video data, image data, or image stream data.

The image capture device 104 can be positioned in the environment 100 such that its field of view can include images of the whole environment 100 or an area or portion of the environment 100. For example, the image capture device 104 can be positioned within the environment 100 such that the image capture device 104 can capture images of the objects 112 within the environment 100, such as an egress (e.g., a door or window) or furniture. The image capture device 104 can be positioned to capture images of persons or animals within the environment 100, such as the entity 110. In some implementations, the zone 106 can coincide with or be determined by the field of view of the image capture device 104. For example, the entirety of the field of view of the image capture device 104 can be the zone 106, or a portion of the field of view can be the zone 106.

The image capture device 104 can be fixed to a structure in the environment 100, such as walls, ceilings, doors or door frames, struts, or rails in the environment 100. The image capture device 104 can be stationary or mobile. The image capture device 104 can be adjustable in position or orientation, such as being adjustably fixed to a structure in the environment 100. For example, the image capture device 104 can include or be coupled with a drive (e.g., any of a motor, gears, linkages, or combinations thereof) that can be used to adjust at least one of a pan angle or tilt angle of the image capture device 104. The image capture device 104 can be adjusted in position or orientation manually or responsive to control of the drive. The image capture device 104 can be adjusted to orient the field of view towards an area of the environment 100, such as the zone 106. The image capture device 104 can have predetermined resolutions or fields of view.

The image capture device 104 can be coupled with the sensors 108 to detect or capture the images and/or to provide non-image related detections. The sensors 108 can be coupled with the image capture device 104. The sensors 108 can be attached to a surface of the image capture device 104 or mounted on the image capture device 104 such that sensors 108 can detect one or more attributes of the environment 100, such as light, movement, moisture, temperature, or sound. For example, the sensors 108 can include light sensors 108 to detect light of the environment 100. The light sensor 108 can be any sensor configured to detect light intensity or brightness, such as a photoresistor, photodiode, or phototransistor. The light sensor 108 can detect light in the visible light spectrum or the invisible light spectrum (e.g., infrared or ultraviolet light). The light sensor 108 can detect an amount of light (e.g., in lumens, lux, degrees Celsius, etc.) within the environment 100. The image capture device 104 can capture images in conjunction with the light sensor 108. For example, the image capture device can adjust a capture of the images of the environment based on the detection from the light sensors 108.

The sensors 108 can include motion sensors 108 to detect movement within the environment 100. The motion sensors 108 can include sensors such as passive infrared sensors (PIR), ultrasonic sensors, accelerometers, gyroscopes, or microwave sensors, among others, to detect movement within the environment and/or one or more zones within the environment. In some implementations, a detection of movement can indicate an entity entering, leaving, or within a zone. The motion sensors 108 can be coupled with the image capture device 104 to detect a motion of the entity 110 related to the behavior and/or body of the entity 110. For example, a motion of the entity 110 can indicate that the entity 110 is a human entity. For example, detecting a motion of the entity 110 by the sensors 108 can include a detection of a gait, gesticulation, particular body movements (e.g., movements of the head or eyes), or movements of the object 112 (e.g., carrying or otherwise moving the object 112) by the entity 110, among others.

The sensors 108 can include temperature sensors 108 to detect heat or temperature within the environment 100. The temperature sensors 108 can include sensors such as thermocouples, resistance temperature detectors (RTDs), thermistors, or infrared (IR) sensors, among others, to detect a temperature or a change in temperature within the zone 106. In some implementations, a detection of a change of temperature or a temperature within a threshold can indicate the entity 110 entering, leaving, or within a zone. In some implementations, if the sensors 108 detect a region of the zone to be within a threshold temperature, the image capture device 104 may capture images of the region corresponding to the threshold temperature.

The sensors 108 can include sound or vibration sensors to detect sound or noise of the environment 100. The sound sensors 108 can include sensors such as microphones, accelerometers, piezoelectric sensors, or laser doppler vibrometers, among others. In some cases, the sound sensors 108 (such as a microphone) can be coupled with the image capture device 104. In some implementations, a detection of a vibration of the ground or the object 112, or a detection of a sound or voice can indicate motion of a given entity 110.

### Camera-Based Machine Vision Architectures

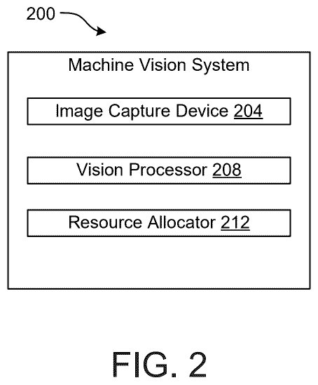

FIG. 2 depicts an example of a machine vision system 200, such as a camera-based machine vision architecture. The machine vision system 200 can be provided as a vision processor and/or accelerator, e.g., including hardware and firmware and/or software components. The machine vision system 200 can used to implement at least a portion of the image capture device 104.

The machine vision system 200 can include at least one image capture device 204. The image capture device 204 can include features of the image capture device 104 described with reference to FIG. 1. The image capture device 204 can include one or more sensors to generate one or more images from light received at the one or more sensors. The image capture device 204 can output the images as a stream of images and/or a video (e.g., image frames and/or video frames). The images can have a frame rate, and can have a resolution. The images can have a quantization, which can represent filtering, scaling, compression, encoding, or other operations performed on the image to modify the images to have target parameters. The image capture device 204 can include one or more camera interfaces to output the images (e.g., as raw data), and can include or be coupled with one or more processors to perform filtering, scaling, color conversion, tone mapping, encoding, and/or decoding (e.g., according to one or more codecs implemented by the machine vision system 200).

The machine vision system 200 can include at least one vision processor 208. The vision processor 208 can include one or more hardware, software, and/or firmware components to perform machine vision operations on the image frames generated by the image capture device 204. In some implementations, the vision processor 208 is or includes a system on a chip (SoC). The vision processor 208 can be tuned or optimized to perform computer vision operations, such as to perform computations used in computer vision operations including in parallel or sequentially according to the operations to be performed. The vision processor 208 can include or be coupled with one or more central processing units (CPUs) and/or graphics processing units (GPUs). The vision processor 208 can be tuned to perform machine vision operations with relatively lower power usage, such as lower power usage than for performing equivalent operations using CPUs and/or GPUs. The vision processor 208 can include one or more optical flow processors, neural networks (e.g., deep learning networks, convolutional neural networks), and/or inference models (e.g., for object detection or tracking). In some implementations, the vision processor 208 includes a first processor to perform machine learning model-based operations, and a second processor to perform non-machine learning model-based operations.

In some implementations, the vision processor 208 includes or is coupled with a resource allocator 212. The resource allocator 212 can provide selected portions of memory and/or processing units for use in deploying machine vision models to be executed on the vision processor 208. For example and without limitation, the resource allocator 212 can perform any of various memory virtualization and/or partition tasks to allocate resources to a given machine vision model. In some implementations, the vision processor 208 includes one or more predefined machine vision models, and the resource allocator 212 can provide for selected access to one or more portions of memory and/or processing units separate from those used for the one or more predefined machine vision models. The resource allocator 212 can include or be coupled with an application programming interface to expose one or more functions of the resource allocator 212.

### Camera System

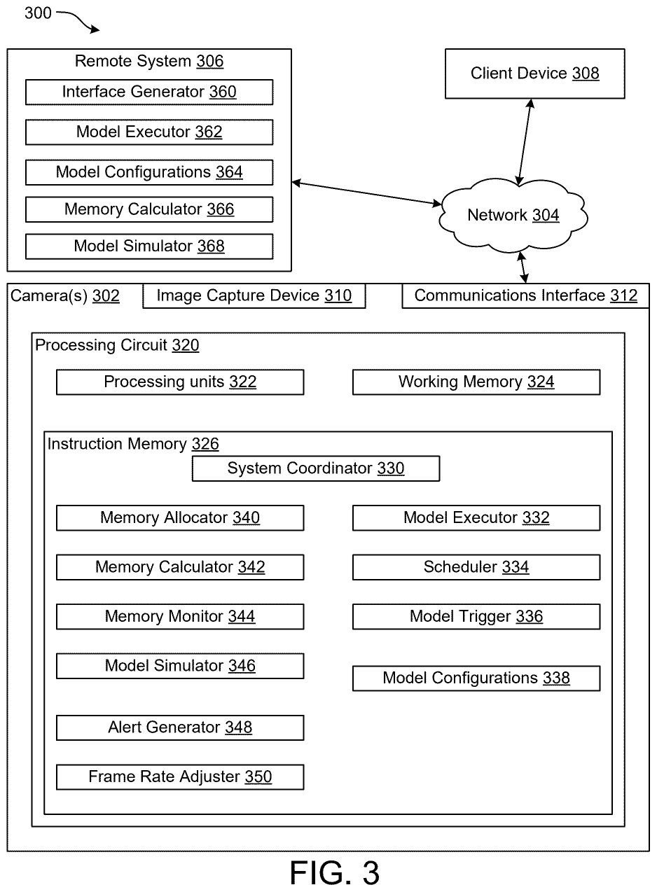

With reference to FIG. 3, system 300 is a machine vision system suitable for executing triggered machine vision models on local camera hardware in accordance with some implementations of the present disclosure. The detection of one feature (e.g., by a machine vision model) can be used to trigger a second machine vision model. The memory and/or processing unit (referred herein as memory/processing unit) allocation can be monitored to ensure the expected frame rate is maintained, triggered machine vision models can run, and/or execution period is maintained. In some implementations, the allocation of memory/processing units can be performed using similar calculations (e.g., allocation techniques); when describing techniques used to allocate and/or predict the allocation of memory/processing units, memory, or processing units it should be understood that any of these terms may relate to memory, processing units, or both. The arrangements described herein are examples only. Other arrangements of the elements and/or additional elements (e.g., devices, components, functions, instructions, etc.) can be used instead of those set forth as the examples. In some implementations, certain elements can be omitted. Many of the elements described can be implemented by discrete and/or distributed components. For example, various functionality can be performed by processors executing instructions stored in memory. In some implementations, the processors and memory can be within an edge device (e.g., the camera). In addition, some implementations can include multiple discrete processors (e.g., a server machine) and/or a distributed processing and storage (e.g., a cloud architecture). The machine vision system 300 can incorporate features of the system 100 described with reference to FIG. 1 and/or the machine vision system 200 described with reference to FIG. 2.

FIG. 3 shows a block diagram of the machine vision system 300 according to some implementations. The machine vision system 300 can include one or more cameras 302, one or more client devices 308, and one or more remote systems 306 all communicating over a network 304. The network 304 can include routers, switches, antennas, computers, and any other hardware required to communicate information between the components of the machine vision system 300 (e.g., from a camera 302 to a remote system 306). A portion of the network 304 can be wireless and/or a portion of the network 304 can be wired.

In some implementations, the machine vision system 300 includes a client device 308. The client device 308 can be used to provide configurations to and/or monitor the one or more remote systems 306 and the one or more cameras 302. The client device 308 can, for example, execute user interface instructions (e.g., JavaScript) delivered from the remote systems 306 and/or the cameras 302. The client device 308 may include an application. For example, a proprietary application specifically for the machine vision system 302 and/or a standard internet browser suitable for executing the interface instructions may be included in the client device 308. The client device 308 can call (e.g., interact with, post, execute, etc.) an application programming interface (API) to configure, monitor, and/or update the devices of the machine vision system 300.

The client device 308 can also include devices that will receive an alert, communication, etc. responsive to the machine vision system 300 detecting a feature. For example, if a security threat is detected, the threat can be communicated to the security system of the building, to the police, etc. using an application and/or API provided by the client device 308. As another example, facial recognition can be used to communicate an identity to the client device 308 (e.g., to provide targeted advertising based on the persons previous purchases).

The machine vision system 300 can include a remote system 306. In some implementations, the remote system 306 is used to configure the camera system, to execute machine vision models that the cameras 302 do not have the processing and/or memory capacity to run, and/or to provide a user interface.

The remote system 306 can include an interface generator 360 to provide a user interface for configuring the camera system. In some implementations this functionality may also (or instead) be stored in memory 326 of camera 302 so that the interface can be provided by a camera 302 (e.g., if no remote system is available or used). The interface generator 360 can include instructions for generating a user interface within which a camera system can be configured. For example, the number of cameras can be chosen, model numbers of the cameras, and machine vision models can be selected to be run on the cameras. As will be described in more detail, the user interface can, in some implementations, simulate or otherwise estimate the memory and/or processing utilization of the cameras 302 given the machine vision models that are expected to be run. The interface generator 360 can provide a display signal to a display device connected to the remote system 306 in order to generate the interface. The interface generator 360 can also send instructions (e.g., JavaScript) to another device (e.g., client device 108) to cause the user interface to be generated. The remote system 306 and/or the cameras 302 can provide application programming interfaces (APIs) to allow the user interface to change the state of the system and/or cameras 302 (e.g., to save a configuration while designing a system, to generate a deployment package capable of configuring the cameras with the models, to deploy the models to the cameras 302, etc.)

In some implementations, the remote system 306 includes a memory calculator 366 to estimate the memory and/or processing required to execute a machine vision model at a particular resolution and/or frame rate. The memory calculator may use a standard set of data provided for each machine vision model suitable for execution on a camera 302 or on the remote system 306. For example, a standard definition of the a machine vision model may include an input resolution, a number of layers, a number of kernels for each layer, a size of the kernels for each layer, a output resolution after each layer, a pooling function used in each layer, and an activation function used in each layer or any other suitable standardized set of data that provides the system 300 with the information required to estimate memory and/or processing usage. The memory calculator 366 can process the standard set of data and determine a memory/processing units estimate at different time utilizations. For example, it may be required that a first amount of memory/processing units be used to complete the processing of the machine vision model in a first amount of time, or if the memory/processing units allocated to the machine vision model is increased to a second amount of memory/processing units, the processing may complete in a lower second amount of time (e.g., due to increased parallelization). Processing time requirements can, for example, be based on the frame rate of the machine vision models.

The memory calculator 366 can also use a memory simulator 368 to simulate the memory and/or processing required to create an estimate of the memory/processing unit requirements in some implementations. The remote system 306 can store various example images, video clips, etc. at different resolutions and color spaces and provide the examples to the memory calculator 366 for the purposes of executing the machine vision model and tracking the memory/processing unit usage. The machine vision model execution can be performed standalone or in combination with other machine vision models to obtain information about the requirements when multiple models are executed concurrently. In some implementations, machine vision models are triggered based on the detection of a feature (e.g., condition, event, etc.) For example, the feature may have been detected by another machine vision model, a sensor, etc. The memory simulator 368 can use statistical properties related to the occurrence of the feature (e.g., entered by the user, learned from historical data, etc.) to determine statistical properties of the memory usage and/or processing power (e.g., maximum, average, amount of time above 80% utilization, etc.)

In some implementations, the remote system 306 includes model configurations 364. The model configurations 364 may be stored within the remote system 306 to provide the user with pre-defined machine vision models that can be deployed to a camera 302, executed locally based on live data communicated from a camera 302, and/or executed locally to perform a memory/processing units estimation. The model configurations 364 can include all the data required to perform a memory/processing unit calculation in the set of standard data and the information required to run the machine vision model (e.g., the weights, layer parameters, etc.)

The remote system 306 can also include a model executor 362. The model executor 362 can execute models (e.g., stored in model configurations 364) to estimate memory and/or processing requirements and/or to perform detections using a machine vision model on live data communicated from a camera 302. In some implementations, the model executor 362 can provide the same or similar functionality to the model executor 332 in a camera 334, but can be targeting different hardware (e.g., a cloud architecture or a graphics processing unit (GPU)).

Referring further to FIG. 3, the machine vision system 300 can include one or more cameras 302. The cameras 302 can use the image capture device 310 (e.g., charge-coupled device sensor, complementary metal-oxide-semiconductor (CMOS) sensor, lens, etc.) to capture an image or sequence of images to execute against machine vision models. The cameras 302 can, for example, execute machine vision models to detect threats, monitor a factory or production facility, be used in targeted marketing and/or sales. Features detected by the camera 302 can be used to produce an alert, select an image or video to display for an advertisement, etc. by communicating to a client device 308. Communication from the cameras 302 can be provided by communications interface 312 over the network 304.

A camera 302 can include one or more processing circuits 320. The processing circuit can include processing units 322 coupled with memory 324 and 326. For the purpose of description, the memory has been divided into working memory 324 and instruction memory 326. It should be understood that a discrete device may provide both working memory 324 and instruction memory 326 in some implementations. Working memory 324 can include global memory (e.g., for storing larger data inputs, models, etc.), shared memory (e.g., for storing and communicating intermediate results during model execution), and local memory (e.g., integrated with the processing units, cache, registers, etc.). Instruction memory 326 can include solid state drives or non-volatile memory, (e.g., for long term storage of instructions) and/or some of the types of memory in working memory 324 to store instructions during their use. The machine vision system 300 may track (e.g., estimate, calculate, etc.) the utilization of the various types of memory separately and/or combined based on the requirements of the system and the machine vision models used.

The processing units 322 can include one or more general purpose processing units and/or one or more specialized processing units (e.g., designed for parallel processing). The processing units 322 can be designed to efficiently perform many of the processes necessary in executing machine vision models. For example, the processing units may be designed to perform a large number of multiplications and additions required in performing while calculating the output of a convolution kernel (e.g., filter).

The camera 302 can include a system coordinator 330. The system coordinator 330 can be configured to control the timing and flow of data through the other circuitry of the camera 302. For example, system coordinator 330 can cause the modules or circuits to execute in a specific order to perform the functions of the camera 302. In some implementations, system coordinator 330 can route the information and/or outputs of other modules that are dependent on the information or use the information as an input. Instructions, functions, portions of memory, etc. described as configured to perform a function (or described as performing the function) may include implementations for which the module is configured to cause the performance of the function (or is causing the performance of the function). For example, describing the functionality of stored instructions of the camera 302. Similarly, instructions, functions, portions of memory, etc. described as configured to cause the performance of a function (or described as causing the performance of a function) may include implementations for which the module is configured to perform the function (or is performing the function).

In some implementations, the camera 302 includes a memory allocator 340. The memory allocator 340 can provision memory/processing units (e.g., from working memory 324) for executing a machine vision model. Memory allocator 340 can determine (e.g., track, store, etc.) the current memory/processing unit utilization and at the time a machine vision model is to run (e.g., scheduled by scheduler 334) determine the memory/processing units that will be used to compete to execute the machine vision model. The memory allocator 340 can receive (e.g., use as an input) the schedule of machine vision models to run, the probability of events that may trigger a machine vision model to run, etc. and determine the amount of memory/processing units to provision. For example, memory allocator 340 can determine to retain some memory/processing units available if another machine vision model is expected to run before the current model will complete.

The memory allocator 340 can perform a trade-off analysis to determine if it is more appropriate to run the machine vision model quickly with a large memory (and/or processing unit) footprint (e.g., a large amount of parallelization), or less quick with a smaller memory/processing units footprint (e.g., more serial). The memory allocator 340 may use, to determine the amount of memory/processing units to allocate, the schedule of machine vision models to run, the probability of events that may trigger a machine vision model to run, the frame rates of the machine vision models to run, and/or the set of standard data that can be used to determine the memory/processing units requirements.

The memory allocator 340 may track the memory/processing unit utilization and the execution of machine vision models. After a machine vision model has completed its execution, the memory/processing units will be released (e.g., the memory allocator 340 can reallocate that memory/processing units). In some implementations, the memory allocator will determine that a machine vision model is using more (or less) memory/processing units than expected based on its standard set of data and take an action responsive to that determination. For example, the memory allocator 340 can update the process for calculating the expected memory/processing unit usage or communicate that need to memory calculator 342. In some implementations, the memory allocator 340 can release memory/processing units used for the execution of one machine vision model to execute another (e.g., higher priority) machine vision model.

By monitoring and/or estimating memory/processing unit usage the camera 302 and the overall machine vision system 300 can more efficiently use the camera hardware for executing machine vision models. For example, more models can be reliably executed on a single camera 302, reducing the number of devices needed. Bottle necks in machine vision execution can be quickly identified to alert an operator and/or redeploy a machine vision model to be executed on another device (e.g., remote system 306 or another camera 302). Monitoring memory and/or processing unit utilization can also ensure that the machine vision model has the required memory/processing units available if it is triggered to run, thus reducing latency when utilization is high (e.g., when many subsequent machine vision models have been executed based on the detection of an event, condition, etc.).

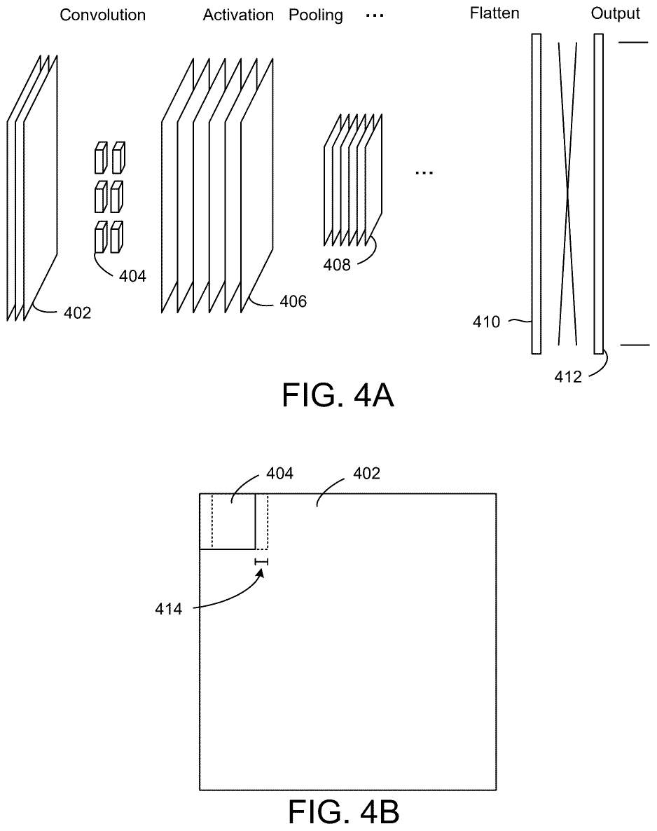

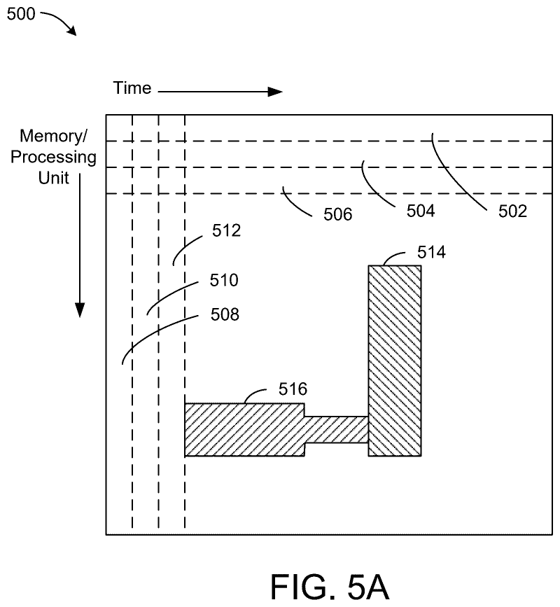

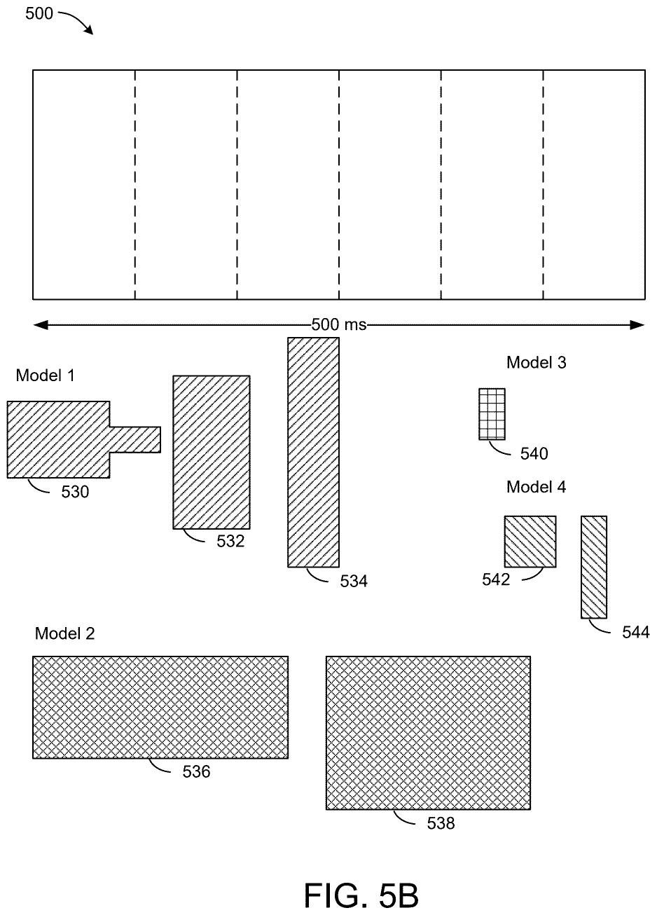

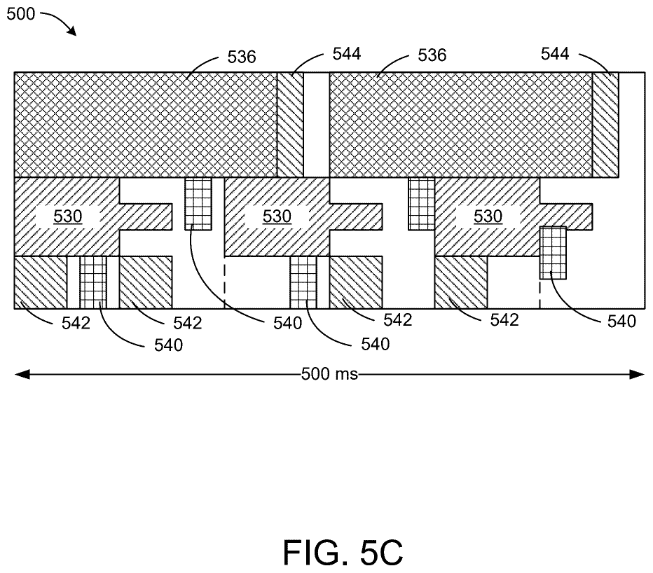

The camera 302 can include a memory calculator 342 to estimate the memory and/or processing required to execute a machine vision model at a particular resolution and/or frame rate. The memory calculator may use a standard set of data provided for each machine vision model suitable for execution on a camera 302 or on the remote system 306. The memory calculator 342 can be similar to the memory calculator 366 of the remote system 306. The functionality of the memory calculator 342 and the memory allocator 340 are described in more detail with reference to FIGS. 4 and 5. Similar to the memory calculator 366 of the remote system 306, the memory calculator 342 can use a model simulator 346 to simulate the memory and/or processing required to create an estimate of the memory/processing unit requirements. The remote system 306 or the camera 302 can store various example images, video clips, etc. at different resolutions and color spaces and provide the examples to the memory calculator 342 for the purposes of executing the machine vision model by memory simulator 346 and tracking the memory/processing unit usage.

The camera 302 can include a memory monitor 344 to monitor the memory/processing unit utilization of the camera. In some implementations the memory monitor 344 causes an alert (e.g., alarm, notification, etc.) to be generated if the memory/processing unit utilization is above a threshold. The memory monitor 344 can include using memory calculator 342 and/or scheduler 334 to determine if memory/processing unit utilization is expected to go above a threshold in the future. In some implementations, the memory monitor 344 includes more than one threshold (e.g., to trigger different actions). For example, the memory monitor 344 can use one utilization (or a predicted utilization) threshold to send a notification, a second threshold to cause an alert to be generated, and a third threshold to rate limit, downscale, or send the machine vision model and/or sequence of images to another device for processing.

In some implementations, the camera 302 includes an alert generator 348. The alert generator 348 can generate various alerts (e.g., alarms, notifications, etc.) responsive to comparisons by memory monitor 344. For example, memory monitor 344 may request that alert generator 348 sends a text message (e.g., SMS) to a registered (e.g., operator's) phone number responsive to the utilization being above 85%. The alert generator 348 can generate alerts including, but not limited to: sending a text message, generating a pop up on a user interface, lighting an LED on the camera 302 body, and/or generating an error code on the camera 302 interface.

The camera 302 can include a frame rate adjuster 350. The frame rate adjuster 350 can adjust the operating parameters of a machine vision model to reduce memory utilization and/or processing units. The frame rate adjuster 350 can adjust the framerate of a machine learning model (e.g., cause it to run less often). Lowering the frame rate can either (i) free up more time that the memory/processing units can be used by other machine vision models during their execution, or (ii) allow the machine vision model to be executed using less memory/processing units (e.g., in a more serial fashion) freeing memory/processing units for other machine vision models. The frame rate adjuster 350 can adjust select a substitute model for execution by the camera 302. For example, the frame rate adjuster may substitute a model operating at 4k resolution for a model operating at 1080p, by causing the video to down-sampled prior to being input to the 1080p machine vision model. Down-sampling can be performed by any suitable filter. For example, down sampling can be performed similar to max pooling in a convolutional neural network (CNN), but potentially with a different function for combining the pixels (e.g., averaging, etc.). The frame rate adjuster 350 can substitute a model with a reduced color space (e.g., 16 bit color rather than 24 bit color) and/or cause the appropriate quantization to be performed. Other methods for reducing the memory and/or processing unit usage, while still maintaining a level of performance similar to what was originally entered or requested can be performed by the frame rate adjuster 350. In some implementations, the machine vision model can process a sequence of images (e.g., a video scene). The sequence of images can be at one frame rate, and the periodicity of the execution can be at another (e.g., slower) rate. The frame rate adjuster 350 can adjust either the frame rate (and provide an appropriate adaptor) or adjust the periodicity of execution to lower the memory/processing unit requirements.

Referring further to FIG. 3, in some implementations, the camera 302 includes a model executor 332 to execute machine vision models (e.g., to process an image or sequence thereof using a machine vision model). The model executor 332 can cause the execution of a model based on the configuration sorted in model configurations 338. For example, the model configurations 338 may store the weights of the machine vision model (e.g., kernels, etc.), the general structure of the layers, the chosen activation functions, etc. and model executor 332 may store instructions for how to execute one portion of the machine vision model. Model executer can include instructions for performing a single convolution calculation (e.g., multiplying the kernel by a section of an image), sliding a convolution kernel across the image, performing a pooling down-sampling operation, performing the activation calculation, etc. Model executer 332 can change the way in which the machine vision model is executed based at least on the memory allocated to that machine vision model. For example, the model executor 332 can run more calculations in parallel if more memory and/or processing units are allocated.

In some implementations, the camera 302 includes a scheduler 334. The scheduler 334 can schedule machine vision models to be run (e.g., based on the time, day, etc. or on a period). For example, the scheduler 334 can execute a machine vision model against each individual image (e.g., frame) of a video scene at the frame rate of the video scene.

Detection of a feature at the location of the camera 302 (e.g., by a periodically run machine vision model, sensor, etc.) can cause the model trigger 336 to trigger the execution of a machine vision model. The model trigger 336 may monitor inputs, e.g., from external sensors communicating over the network or the output of other machine vision models executed by model executor 332 and cause the execution of a subsequent machine vision model based on the inputs (e.g., responsive to a comparison to a threshold, a positive identification, etc.). For example, a facial recognition model can include a trigger related to first detecting a person. The model trigger 336 can monitor the output of a person detection model and trigger the execution of the facial recognition model based on a positive detection. A threat type classifier can be triggered by a threat detector, a production stoppage detector can trigger a root cause detector, a course object detection may cause another fine-tuned object detection to run with smaller receptive field including a crop of the image around a region of interest etc. In some implementations, a trigger is part of the standard data set (e.g., standard data interface).

FIGS. 4A and 4B are illustrative diagrams of operations during the execution of a CNN and along with FIG. 5 are used to describe the memory/processing unit calculation within the machine vision system 300.

With reference to FIG. 4A, the input to a CNN includes one or more images 402. The images 402 can include multiple color channels of the same image, and/or sequential images of a video scene. The images 402 are convolved (e.g., filtered, blurred, etc.) using a kernel (e.g., kernel 404) (e.g., filter) of various weights. Each kernel 404 produces a feature map 406 (e.g., a filtered version) of the one or more images by performing an element-wise multiplication of the kernel 404 by a region of the one or more images 402, summing the product, and then translating the kernel to a different region by a stride amount 414.

As shown in FIG. 4B, the kernel 404 is aligned with a region of an input image 402. Element-wise multiplication can be performed to obtain an element (e.g., pixel, neuron, etc. of the feature map 406. The kernel is sifted by the stride amount 414 and the multiplication is performed to obtain the next element. This process is repeated to generate the entire feature map 406.

The memory calculator 342 can estimate the memory and/or processing requirements to execute the CNN. For example, the memory calculator can estimate a memory (e.g., together with a processing unit) size equal to two times the number of elements of the largest kernel (e.g., a 5×5 kernel would require at least 50 processing/memory units). Using only 50 memory/processing units could require all kernels 404 to be applied serially. The execution of the CNN can be parallelized spatially (e.g., the number of locations where a kernel 404 is applied), across multiple channels or sequential images, and/or across multiple kernels (e.g., multiple kernels 404 can be executed against the same image in parallel). Memory calculator 342 can estimate the memory/processing units required if kernel execution is parallelized. For example, if six 5×5 kernels 404 were applied in parallel, memory calculator 342 could estimate 300 memory/processing units and could complete the execution in a sixth of the time.

Referring back to FIG. 4A, after the feature map 406 is generated using the convolution kernels 404, an activation function (e.g., a sigmoid, rectified linear unit, etc.) can be applied to each element to add nonlinearity and increase representative capability of the CNN. The activation function can be followed by a pooling operation (e.g., max pooling, average pooling etc.) to generate a reduced size feature map 408. Activation and pooling depend on the results of applying the kernels 406 and it may not be possible to perform pooling in parallel with earlier operations within the network.

The CNN can contain several repeated layers of convolution, activation, and pooling prior to flattening the channels of a last feature map into a single vector embedding 410 and performing the calculation of one or more fully connected layer to get the output 412.

In some implementations, the memory calculator 342 can maintain (e.g., generate, store, modify, etc.) a representation of expected memory/processing unit allocation for a future (e.g., repeated) time period. The representation can, for example, include a time period that is as long as the longest execution period in order to represent a model execution plan that will be repeated periodically by the camera 302.

FIG. 5 shows an illustration of a model execution plan 500, according to some implementations. The model execution plan represents a target, goal, prediction, etc. of the memory/processing unit allocations for a camera given a set of machine vision models scheduled to run on the camera. In model execution plan 500, a row can be used to show a utilization of a single memory/processing unit as a function of time (e.g., row 502 represents the first memory/processing unit, row 504 represents the second memory/processing unit, and row 506 represents the third memory/processing unit). A column can be used to show the utilization of all the memory/processing units at a single time slice (e.g., a microsecond, millisecond, or any other time resolution that is convenient for performing allocation planning). For example, the first column 508 may represent the next time slice to be executed or the first one of a repeated plan. The second column 510 and third column 512 may represent subsequent time slices within the model execution plan 500. The model execution plan 500 can be used by the memory allocator 340 to efficiently allocate memory/processing units at model execution time.

As described herein, the memory calculator 342 can be used to determine a static memory/processing unit allocation (e.g., for machine vision models expected to run) based on information (e.g., metadata, layout, etc.) related to the machine vision models. In some implementations, the memory calculator 342 can determine a dynamic memory/processing unit allocation during runtime by updating the static (expected) allocation based on current running conditions (e.g., execution of triggered machine vision models, using more processing units than expected, processing units occupied by other system level processes, etc.).

In the model execution plan 500, a memory/processing unit allocation (e.g., reservation, provision, etc.) can be represented by a region indicating the memory/processing units and the time for which the memory/processing units are allocated. A memory calculator (e.g., the memory calculator 366 and/or the memory calculator 342) can determine the suitable allocations from a standard data set associated with the machine vision model). A first model allocation 514 can represent the memory/processing unit allocation for a highly parallelized machine vision model. The first model allocation 514 is tall indicating a large number of memory/processing units are used and the first model allocation 514 is thin indicating it only reserves the memory/processing units for a short period of time. A second model allocation 516 can represent the memory/processing unit allocation for a machine vision model that is running less parallel memory/processing units, but for a longer time period. The total area of an allocation can be indicative of the total computational complexity (e.g., number of computations performed) to execute the machine vision model. For example, the model using allocation 514 and the model using allocation 516 appear to be of similar computational complexity. In some implementations, memory/processing units are released during the execution of a model. For example, later stages of the model can operate on feature maps that are of smaller size, have smaller kernels, use fewer kernels, etc. such that some memory/processing units can be released during the execution of the model. The second model allocation 516 is of a smaller height later in the allocation, indicating that the model using the allocation 516 can release roughly half of its memory/processing units two-thirds of the way through the execution.

In some implementations, at least one function of a memory calculator (e.g., the memory calculator 366 and/or the memory calculator 342) is to determine efficient memory/processing unit execution plans for model execution. To determine a repeatable execution plan, a time period after which all model executions are repeated can be determined. The least common multiple of all the model execution periods can be used as the time period of the execution plan. For example, if a camera is configured to execute four machine vision models: model one at six times per second, model two at four times per second, model three at ten times per second, and model four at twelve times per second, the period of the execution plan may be half of a second (e.g., three executions of model one, two executions of model two, five executions of model three, and six executions of model six). In some implementations, the machine vision system 300 allows models to run a number of times per second that are divisible by a small set of numbers (e.g., two, three, and five) to prevent long executions plans that would result if a model was executed a large prime number of times per second (e.g., 59).

In some implementations, the memory calculator (e.g., the memory calculator 366 and/or the memory calculator 342) has knowledge of several different allocations suitable to run a model (e.g., highly parallel, or less parallelization). The memory calculator may decide the method that best suits the execution of the models. FIG. 5B shows a model execution plan 500 with three suitable allocations for model 1, illustrated by allocation 530-534, two suitable allocations for model 2, 536 and 538, one allocation 540 for model 3, and two allocations 542 and 544 for model four. Note that the shape of the allocation may or may not be important. In some implementations, there is an advantage in using spatially nearby memory/processing units to execute a single model. For example, spatially nearby memory/processing units can provide lower data transfer latency. However, data allocations can be of any shape that has the same amount of memory/processing units in sequential time slots (e.g., the allocations can be of disjoint shapes). It is noted that, in some implementations, the memory/processing units are not oriented in a linear array on the chip and the 2-dimensional representation of the model execution plan 500 used for this discussion would not accurately represent physical distance between memory/processing units.

The memory calculator (e.g., the memory calculator 366 and/or the memory calculator 342) can determine how to allocate memory/processing units for various machine vision modes into a repeated model execution plan 500. As shown in FIG. 5C the model execution plan 500 has allocations to run model one three times (using allocation 530), model two two times (using allocation 536), model three five times (using allocation 540), and model four six times (using allocation 542 and 544). The memory calculator can determine the allocations using several constraints (e.g., criteria) that are expected to be satisfied and one or more objectives. The model execution plan can have constraints related to the number of times the model must be executed, an earliest time the model can start its execution, and a latest time the model can complete it execution (e.g., as determined by the desired model execution period, the frame rate of the video capture, when an image or sequence thereof is obtained, etc.). The model execution plan can have constraints related to the number the shape of the suitable allocations of the model (e.g., the amount of memory/processing units required at sequential instances of time). The model execution plan can have constraints related to the camera model number (e.g., the amount of memory/processing units available on the camera). The model execution plan can be determined based at least on one or more objectives. For example, the objectives may be related to having as much free memory/processing units and time as possible, having memory/processing units to run the largest amount of triggered models (e.g., models that run based on the results of other models), violates the least number of constraints, has the most idle time, has the most consistent memory/processing unit allocation (e.g., consistent utilization), etc.

In some implementations, the memory calculator (e.g., the memory calculator 366 and/or the memory calculator 342) can perform a type of optimization process to determine an allocation that satisfies the constraints (and/or minimizes the constraint violations) and performs well relative to the objective function (e.g., low value if the objective is to be minimized or high value if the objective is to be maximized). For example, the memory calculator can perform a knapsack optimization or solve a linear program that have been formulated for the memory/processing unit allocation problem. The objective function can also (or instead) perform a greedy allocation. For example, by allocating the computationally expensive models first (e.g., the models that require the largest product of memory/processing units multiplied by the time the memory/processing units) and then filling in (subject to the constraints) the model execution plan 500 with the less computationally expensive models.

The operations described herein can be performed by the memory calculator 366 on the remote system 306. For example, the memory calculator 366 can determine if a configuration will perform as desired when deployed on a camera by generating an allocation and determining if all the constraints can be satisfied. The operations described herein can be performed by the memory calculator 342 on the camera 302 (e.g., to also determine if a configuration will perform as desired and/or determine the model execution plan that the camera 302 will use). In some implementations, the camera has no memory calculator 342 and model execution plans 500 are sent to the camera 302 as part of the deployment process.

In some implementations, the model execution plan 500 is modified by memory calculator 342 if a model is triggered. For example, the frame rate adjuster 350 may modify the frame rate of the sequence of images supplied to the machine vision model or the execution period of the machine vision model. In some implementations, an alert is generated if one or more constraints are violated (e.g., as described with reference to alert generator 348).

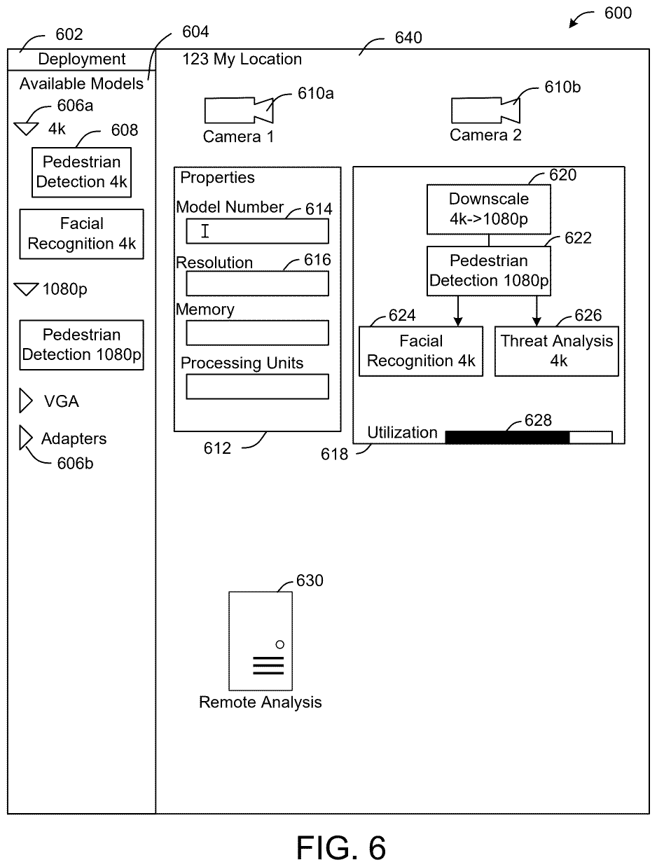

FIG. 6 shows a user interface 600 that can be generated by interface generator 306 according to some implementations. For example, the interface can be displayed on a display device of the remote system 306 and/or client device 308. The user interface 600 can be used to configure a machine vision system 300 (e.g., configure the models to be run on various cameras). The user interface 600, can also be used to deploy (e.g., upload, transfer, etc.) a configuration to the cameras.

The user interface 600 can include tabs 602 in some implementation. The tabs 602 can be used to switch between different functionality of the user interface 600. For example, @tabs can switch between a palette area, for configuration, and a deployment area, for entering deployment options.

The user interface 600 can include a palette area 604 in some implementations. The palette 604 can include dropdown menus (e.g., dropdown menu 606a and 606b) that include various machine vision models (e.g., machine vision model 608) that can be executed on some the cameras of machine vision system 300. For example, the dropdown menus can divide the machine vision models by resolution as shown in FIG. 6. In some implementations, the user interface can provide adapters (e.g., within dropdown menu 606b). Adaptors can provide algorithms that adapt a machine vision model to a camera. For example, a camera may operate at particular quantization (e.g., color space, number of bits used to represent a color channel, frames per second, and/or resolution) and a machine vision model may not work well if it was not trained for the same quantization. Adapters can be provided that upscale/downscale the resolution of the images, change the frames per second, and/or change the numeric representation of the colors (e.g., number of bits used; meaning of the bits: red-green-blue, hue-saturation-lightness, etc.) to match the machine vision model's expected input to the images and/or sequences thereof provided by the camera.

The user interface 600 can include a design area 640. The design area 640 can provide an area where the current machine vision system 300 configuration is shown. The design area 640 can include a representation for each camera of the machine vision system 300. For example, icons 610a and 610b can indicate a camera and provide a user interface object that can be interacted with to configure the camera and/or the machine vision models running thereon. The camera icon 410a is shown in FIG. 6 to have been used to open a properties menu 612. The properties menu 612 can contain editable fields (e.g., editable field 614 to provide a camera model number) and display fields (e.g., display field 616 to provide read only information about the resolution of the selected camera). The camera icon 610b is shown in FIG. 6 to have been used to open a machine vision layout window 618.

The layout window 618 can provide an area within which machine vision models can be dragged (or other suitable interaction) from the palette to the camera. Within the layout window 618 a user can connect an adapter to a machine vision model. For example, an adapter 620 is shown to convert the resolution of a 4k camera to the 1080p input expected by the pedestrian detection model 622. Within the layout window 618 a user can connect a detection output of one machine vision model to the trigger of another machine vision model. For example, the output of the pedestrian detection model 622 can be added to the model trigger 336 to be monitored and cause the execution of both a facial recognition model 624 and a threat analysis model 626. As machine vision models are added to a camera the memory calculator 366 can add the model to a model execution plan of the camera and update the memory/processing unit utilization bar 628 based on the current models, frame rates, etc. that are desired to be run. In some implementations, the user interface 600 can provide, for example in the layout window 618, the ability to modify the constraints or objective of the model calculator 366 and/or allow the user to manipulate the calculated model execution plan 500.

The design area 640 can include an icon for remote analysis 630. The icon for remote analysis 630 can allow the user to assign machine vision models to be executed remotely (e.g., by drag and drop of a model onto the icon for remote analysis 630. When configuring remote analysis the user interface 600 can allow the user to enter the camera(s) for which the remote analysis (e.g., remote execution of a machine vision model) will be performed, frame rate of the analysis, and/or any other constraints or other information related to the remote execution of the machine vision models.

The user interface 600 can provide a button that will execute a function (e.g., callback, API, etc.) to generate a machine vision deployment package for the cameras and/or remote system 306. The deployment package may contain instructions for executing the machine vision models, the configuration of the machine vision models (e.g., weights, layers, etc.), the adapters, and/or the configuration of any triggers. The deployment packages, for example, can be uploaded to the cameras 302 through an API or by downloading a deployment to a media card (e.g., SD card) and inserting it into the camera.

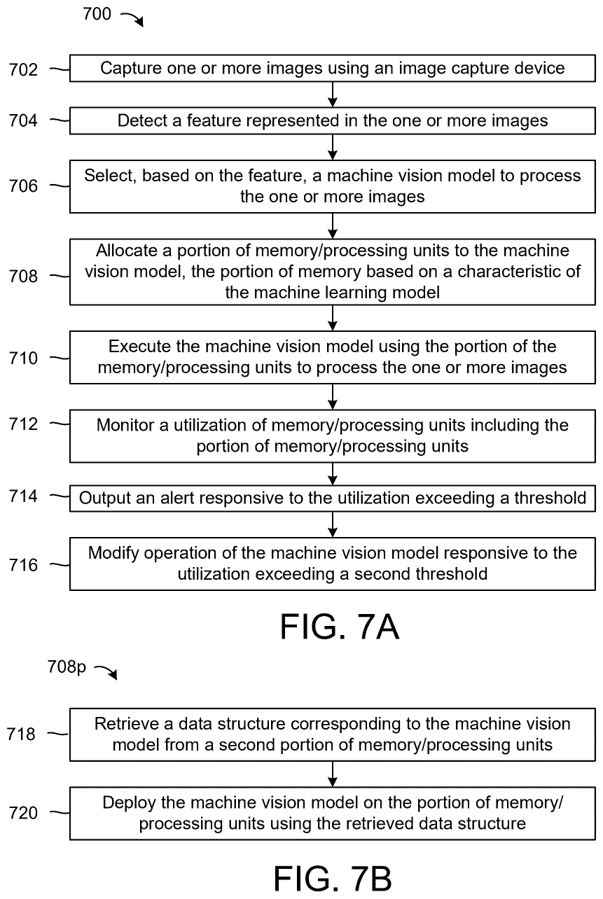

FIGS. 7A and 7B show methods for allocating memory/processing units and during camera operation and generating alerts if the memory/processing unit utilization exceeds a threshold. The flow of operations can for example be performed responsive to detecting a feature in one or more images of an image capture device (e.g., the camera(s) 302). The flow of operations can also be run as part of scheduled operation (e.g., triggered by the scheduler 334) as determined by memory calculator 342. Each block of the methods described herein can include a computing process, for example, instructions stored in memory and executed by the one or more processing units 322.

FIG. 7A is a flow diagram showing a method 700 for allocating memory/processing unit utilization of a machine vision model and generating an alarm and/or modifying operations if the utilization exceeds a threshold. Method 700 can be carried out or executed by the machine vision system 300 presented herein (e.g., by a camera 302 and/or by a remote system 306.

The method 700, at block 702, can include capturing one or more images using an image capture device. For example, a camera may focus light by use of a lens onto a sensor (e.g., charge-coupled device sensor, complementary metal-oxide-semiconductor (CMOS) sensor, etc.). The sensor can be sampled at a predefined period (or on demand) and the images converted to a digital signal and transmitted, for example, over a communications bus to the processing circuitry of the camera 302. The digital signal can be transmitted using parallel or serial communication interfaces (e.g., a serial peripheral interface (SPI), a I2C bus, etc).

The method 700, at block 704, can include detecting a feature represented in the one or more images. Feature detection can be performed by rule-based logic (e.g., template matching, edge detection, etc.). In some implementations, the feature can be a more general feature, for example, satisfying a statistical criterion. Color change and/or brightness histograms can include or be related to a detected feature. Statistical image transforms (e.g., wavelet transforms, Radon transforms, Hough transforms, etc.) can be computed and used to detect the presence of a feature in an image. A feature can be detected using a sequence of images, for example, a feature may be related to changes of the image between consecutive images. In some embodiments, sensors (e.g., other than those of the camera(s) 302) can be used to detect a feature (e.g., an occupancy sensor can be used to trigger facial recognition to identify the person in the area.)

The method 700, at block 706, can include selecting, based on the feature a machine vision model to process the one or more images. For example, the model trigger 336 may perform the operations at block 706 using information entered via the user interface 600 during the configuration process. A facial recognition model can be selected based on first detecting a person in the one or more images. A threat type classifier can be selected based on a positive detection of a threat. A root cause detector can be selected if a production stoppage is detected (e.g., by machine vision models, operators, and/or other production line sensors). In some implementations, a course object detection can cause another fine-tuned object detection to be selected with smaller receptive field including a crop of the image around a region of interest.

The method 700, at block 708, can include allocating a portion of memory/processing units to the machine vision model. The portion of memory/processing units can be based on a characteristic of the machine learning model. The portion of memory/processing units can be based on at least one of the number of layers of the machine vision model, the number of convolution kernels (e.g., filters) at each layer, the desired execution rate, etc. In some implementations, suitable allocations for executing a machine vision model are stored as part of a standard set of data associated with the machine vision model. The memory calculator 342 can determine an appropriate allocation based at least on the characteristic and communicate the information to the memory allocator 340 so that the memory/processing units are allocated. After determining an appropriate memory/processing unit allocation, the operations at block 706 can also include determining the best time to execute the machine vision model and the region of the memory/processing units to be used during execution. Allocating a portion of memory/processing units to the machine vision model can also include determining a target memory/processing unit usage (e.g., an amount of memory/processing units, the specific memory/processing units, etc.) FIG. 7B is a flow diagram showing a method 708p for allocating the portion of memory/processing units to the machine vision model based at least on a characteristic of the model. The method 708p can be a more detailed process for performing the operations at the block 708.

The method 708p, at block 718, can include retrieving a data structure corresponding to the machine vision model from a second portion of memory/processing units. The data structure can include the machine vision model itself and/or metadata related to the machine vision model that is standard to the data structure for each machine vision model. For example, the metadata in the data structure can include can the number of layers of the machine vision model, the number of convolution kernels (e.g., filters) at each layer, the desired execution rate, etc. In some implementations, suitable allocations for executing a machine vision model are stored as part of a standard set of data associated with the machine vision model. In some implementations, a type of optimization can be performed to determine a suitable allocation (e.g., as described with reference to memory calculator 342.

The method 708p, at block 720, can include deploying the machine vision model to the portion of memory/processing units using the retrieved data structure. For example, the after an allocation is determined using the data structure the machine vision model can be deployed by communicating the memory allocator 340 and the model executor 332 to be run on the determined portion of memory/processing units.

With reference to FIG. 5A, the method 700, at block 710, can include executing the machine vision model using the portion of the memory/processing units to process the one or more images. For example, the model can be executed on the target memory/processing units determined in the operations of block 708 by the model executor 332.

The method 700, at block 712, can include monitoring a utilization of the memory/processing units allocated to various machine vision models or other operations including the portion of memory/processing units allocated in response to the feature detected in the operations of block 704. Monitoring the utilization can include comparing the current utilization (e.g., after the most recent allocation) and comparing the utilization to a threshold utilization. Multiple thresholds may be used to trigger various responses if the thresholds are exceeded. For example, the method 700, at block 714 can include outputting an alert responsive to the utilization exceeding the threshold (e.g., using the alert generator 348). The alert generator 348 can generate alerts including, but not limited to: sending a text message, generating a pop up on a user interface, lighting an LED on the camera 302 body, and/or generating an error code on the camera 302 interface. As another example, the method 700, at block 716 can include modifying operation of the machine vision model responsive to the utilization exceeding a second threshold. The execution period, frame rate, quantization, of the machine vision model can be changed in response to excessive memory/processing unit utilization. In some implementations the memory/processing units allocated to other machine vision models can be modified to accommodate the machine vision model for which memory/processing units are being allocated.

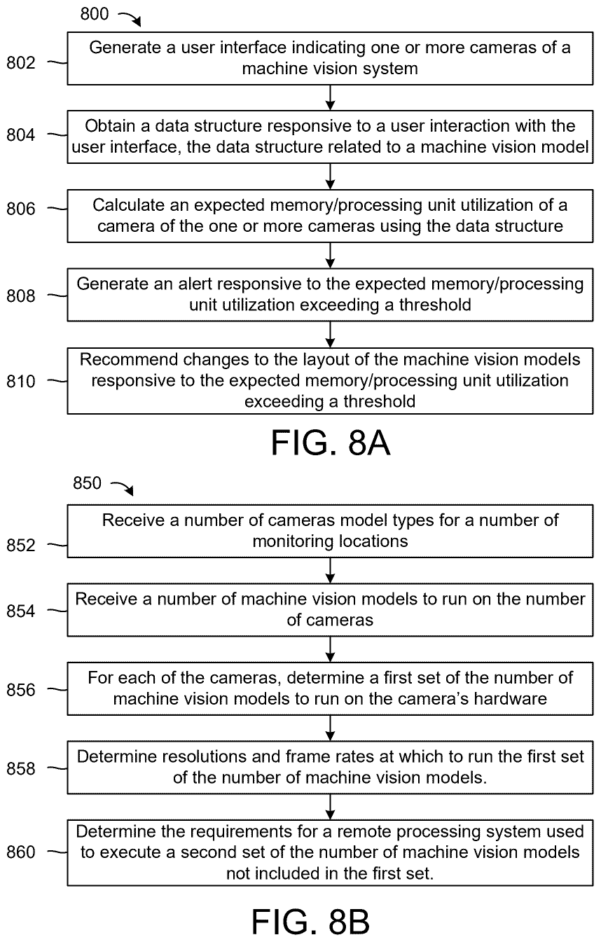

FIG. 8A shows a method 800 for deploying models of a machine vision system using a user interface according to some implementations. The method 800 can be run by the machine vision system 300, for example, by the interface generator 360 and memory calculator 366. The method 800 can be used to alert the designer (e.g., user of the user interface) to problematic memory/processing unit allocations and/or recommend changes to the machine vision models running in the machine vision system 300.

The method 800, at block 802, can include generating a user interface indicating one or more cameras of the machine vision system 300. The block 802 can include generating a user interface similar or containing some of the elements of user interface 600 described with reference to FIG. 4@. The operations can be performed to provide a display signal to a display device connected to the remote system 306 in order to generate the interface. The interface generator 360 can also send instructions (e.g., JavaScript) to another device (e.g., client device 108) to cause the user interface to be generated. The remote system 306 and/or the cameras 302 can provide application programming interfaces (API) to allow the user interface to change the state of the system and/or cameras 302 (e.g., to save a configuration while designing a system, to generate a deployment package capable of configuring the cameras with the models, to deploy the models to the cameras 302, etc.).

The method 800, at block 804, can include obtaining a data structure responsive to a user interaction with the user interface. The data structure can be related to a machine vision model. A machine vision model can be selected by a user from a set of predefined machine vision models. For example, a user may drag a machine vision model from a palette area to a representation of a camera in order to cause that machine vision model to be deployed on the camera. In some implementations, the user interface can provide a machine vision model ecosystem where users can publish their machine vision models and make them available for use or purchase by others with a similar machine vision system and/or cameras. The machine vision models provided by third parties can go through a verification process to ensure the machine vision models will perform as expected. The machine vision models provided by third parties can also be required to provide the same or similar data structure so that they can be executed using the framework of machine vision system 300. For example, all machine vision models can be published using the same type of containerization for easy deployment.

The method 800, at block 806, can include calculating an expected memory/processing unit utilization of a camera that is to use the data structure (e.g., to allocate the memory/processing units to execute the machine vision model). The operations of the block 806 can include any of the operations and/or functionality described with reference to the memory calculators 366 or 342 or with reference to the generation of model execution plans (e.g., model execution plan 500). By generation a model execution plan the operations can also estimate a utilization and/or estimate other statistics related to the capacity of a machine vision model processing circuitry of a camera to execute additional machine vision models.

The method 800, at block 808, can include generating an alert responsive to the expected memory/processing unit utilization exceeding a threshold. Alerts described with reference to the alert generator 348 and/or block 714 can be performed. In addition, alerts may be generated on the user interface 600 at configuration time (e.g., as machine vision models are dropped into a representation of a camera on the user interface 600. The alert can take the form of an audible alert (e.g., ping, chime, etc.) a pop-up message, and/or not allowing the machine vision model to be dropped onto the representation of the camera (e.g., changing the pointer graphic or model graphic as it is dragged over the representation of the camera).

The method 800, at block 810, can include recommending changes to the layout of the machine vision models responsive to the expected memory/processing unit utilization exceeding a threshold. For example, the execution period, frame rate, quantization (e.g., color space, number of bits used to represent the color, etc.) of the machine vision model can be changed in response to excessive memory/processing unit utilization. The method 800 may also recommend moving one or more machine vision models to be executed by the remote system 306.

FIG. 8B shows a method 850 for determining the configuration of a machine vision system and determining the requirements of a remote system capable of running the machine vision models that cannot be run at the camera. The method can include determining which machine vision models can run on the camera hardware and maybe based on a set of constraints that related to how often the machine vision models are required to execute, the memory/processing unit requirements of the machine vision models, etc. The method 850 can, for example, be performed by the interface generator 360 and/or the memory calculator 366 of the remote system 306.

The method 850, at block 852 can include receiving a number of cameras model types for a number of monitoring locations. The camera model information can be entered via a user interface 600. For example, a user can enter a number of monitoring locations for a machine vision system and associated a respective camera with the location.

The method 850, at block 854, can include receiving a number of machine vision models to run on the number of cameras. The user, for example, can associate one or more machine vision models with a camera as described with reference to the user interface 600. In some implementations the user can also enter information related to constraints for running the machine vision models. For example, the operations at block 854 can include receiving the period at which a model must be executed, an earliest time the model can start its execution, and a latest time the model can complete it execution (e.g., as determined by the desired model execution period, the frame rate of the video capture, when an image or sequence thereof is obtained, etc.).

The method 850, at block 856, can include determining, for each of the cameras, a first set of the number of machine vision models to run on the camera's hardware. For example, the memory calculator (e.g., the memory calculator 366) can perform a knapsack optimization or solve a linear program that has been formulated for the memory/processing unit allocation problem. The objective function can also (or instead) perform a greedy allocation. For example, by allocation the computationally expensive models first (e.g., the model that requires the largest product of memory/processing units multiplied by the time the memory/processing units are used) and then filling in (subject to the constraints) the model execution plan with the less computationally expensive models. In some implementations, the camera hardware will not be able to satisfy the constraints (e.g., the memory/processing unit requirements of the machine vision models will be greater than what the camera hardware can provide) and the constraints can be violated to some amount and/or one or more of the machine vision models can be designated to be executed on the remote system 306.

The method 850, at block 858, can include determining resolution, execution period, frame rate, quantization, etc. of the machine vision models running on a camera that does not meet the memory/processing unit requirements of the machine visions models associated with a camera. For example, operations may be performed that attempt to minimize the number of constraint violations and/or the amount by which constraints are violated. In some implementations, instead of (or in addition to) violating constraints some machine vision models may be designated to be run in the remote system 306. Machine vision models running on the remote system 306 can be subject to constraints on communication traffic, latency, etc. of sending the video from the camera 302 to the remote system 306 and receiving the result from the remote system 306 by the camera 302.

The method 850, at block 860, can include determining the requirements for a remote processing system (e.g., the remote system 306) used to execute a second set of the number of machine vision models that were not included in the first set found in the operations of block 858 (e.g., due to memory/processing unit violations).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the implementations disclosed herein can be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor can be a microprocessor, or, any conventional processor, controller, microcontroller, soc (system on chip), som (system on module) or state machine. A processor also can be implemented as a combination of computing devices, such as a combination of a DSP and a microprocessor, a plurality of microprocessors, one or more microprocessors in conjunction with a DSP core, or any other such configuration. In some implementations, particular processes and methods can be performed by circuitry that is specific to a given function. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. The memory can be or include volatile memory or non-volatile memory, and can include database components, object code components, script components, or any other type of information structure for supporting the various activities and information structures described in the present disclosure. According to an exemplary implementation, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The implementations of the present disclosure can be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or implementation, and references to “an implementation,” “some implementations,” “one implementation” or the like are not necessarily mutually exclusive and are intended to indicate that a particular feature, structure, or characteristic described in connection with the implementation can be included in at least one implementation or implementation. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein can be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining can be stationary (e.g., permanent or fixed) or moveable (e.g., removable or releasable). Such joining can be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling can be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements can differ according to other exemplary implementations, and that such variations are intended to be encompassed by the present disclosure.

What is claimed is:

1. A camera, comprising:
an image capture device to output one or more images; and
one or more processors coupled with memory, the one or more processors to:
detect a feature represented in a first image of the one or more images;
select, based on the feature, a machine vision model to process at least one of the first image or a second image of the one or more images;
allocate, to the machine vision model, based on a characteristic of the machine vision model, a portion of the memory; and
execute the machine vision model using the portion of the memory to process the at least one of the first image or the second image.

2. The camera of claim 1, wherein the machine vision model is a second machine vision model, the portion of the memory is a second portion of the memory, and the one or more processors are to:
detect the feature represented in the first image by causing a first machine vision model to execute on a first portion of memory.

3. The camera of claim 1, wherein the one or more processors are to determine an amount of the portion of memory to allocate to the machine vision model based on at least one of a frame rate associated with the one or more images or a resolution of the one or more images.

4. The camera of claim 1, wherein the one or more processors are to:
monitor a utilization of the memory by the machine vision model; and
output an alert responsive to the utilization exceeding a threshold.

5. The camera of claim 1, wherein the one or more processors are to:
monitor a utilization of the memory by the machine vision model; and
modify operation of the machine vision model responsive to the utilization exceeding a threshold.

6. The camera of claim 1, wherein the portion of the memory is a second portion of the memory, and one or more processors are to:
retrieve a data structure corresponding to the machine vision model from a first portion of the memory; and
deploy the machine vision model on the second portion of the memory using the retrieved data structure.

7. The camera of claim 1, wherein the one or more processors are to select the machine vision model from a plurality of machine vision models.

8. The camera of claim 1, wherein the machine vision model comprises a neural network to perform at least one of object detection, object tracking, or alarm generation.

9. The camera of claim 1, wherein the one or more processors are to allocate the portion of memory to include at least one of a minimum threshold amount of the memory or a maximum threshold amount of the memory.

10. The camera of claim 1, wherein the image capture device is to output the one or more images according to a predetermined quantization, and the machine vision model is configured to process the one or more images according to the predetermined quantization.

11. The camera of claim 1, wherein the image capture device is to output the first image and the second image as a sequence of images at a frame rate.

12. A method, comprising:
selecting, by processing circuitry of a camera, a machine vision model to process one or more images from an image capture device of the camera;
allocating a portion of memory of the camera, by the processing circuitry, based on a characteristic of at least one of the one or more images or the machine vision model; and
executing, by the processing circuitry, the machine vision model on the portion of the memory to process the one or more images.

13. The method of claim 12, wherein the characteristic comprises at least one of a frame rate associated with the one or more images or a resolution of the one or more images.

14. The method of claim 12, wherein the machine vision model is a second machine vision model, the portion of the memory is a second portion of the memory, and the method further comprises:
detecting, by the processing circuitry, the feature represented in the first image by causing a first machine vision model to execute on a first portion of memory.

15. The method of claim 12, further comprising:
monitoring, by the processing circuitry, a utilization of the portion of the memory by the machine vision model; and
output an alert responsive to the utilization exceeding a threshold.

16. The method of claim 12, wherein the portion of the memory is a second portion, the method further comprising:
retrieving, by the processing circuitry, a plurality of weights and biases corresponding to the machine vision model from a first portion of the memory; and
deploying, by the processing circuitry, the machine vision model on the second portion of the memory using the plurality of weights and biases.

17. The method of claim 12, wherein the machine vision model comprises a second machine vision model, the method further comprising:
detecting, by the processing circuitry, using a first machine vision model, a feature of an object represented in the one or more images;
selecting, by the processing circuitry, the second machine vision model based on the feature; and
processing, by the second machine vision model, the feature to detect a characteristic of the feature.

18. A system, comprising:
one or more processors to:
detect an object in image data from an image capture device, the object having a class;
select, based on the class, a machine vision model to process the image stream;
determine a target memory usage for the machine vision model; and
execute the machine vision model, on a portion of memory corresponding to the target memory usage, to generate an output regarding the object based on the image data.

19. The system of claim 18, wherein the one or more processors are to:
monitor utilization of the portion of memory by the machine vision model; and
update operation of the machine vision model responsive to the utilization exceeding a threshold.

20. The system of claim 18, wherein the machine vision model is to determine a state of the object based on the image data.
